(19) United States
(12) Patent Application Publication
(10) Pub. No.: US 2008/0050617 A1
(43) Pub. Date: Feb. 28, 2008

(54) CATALYST FOR OXIDIZING CARBON MONOXIDE FOR REFORMER OF FUEL CELL, METHOD FOR PREPARING THE SAME, AND FUEL CELL SYSTEM INCLUDING THE SAME

(75) Inventors: Leonid Gorobinskiy, Yongin-si (KR); Ju-Yong Kim, Yongin-si (KR); Jin-Kwang Kim, Yongin-si (KR); Dong-Myung Suh, Yongin-si (KR); Jin-Goo Ahn, Yongin-si (KR); Dong-Uk Lee, Yongin-si (KR); Sung-Chul Lee, Yongin-si (KR); Man-Seok Han, Yongin-si (KR); Chan-Ho Lee, Yongin-si (KR); Yong-Kul Lee, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd, Suwon-si (KR)

(21) Appl. No.: 11/751,942

(22) Filed: May 22, 2007

(30) Foreign Application Priority Data
Aug. 23, 2006 (KR) 10-2006-0079975

(51) Int. Cl. H01M 8/00; B01J 23/18; B01J 23/72; B01J 27/057

(52) U.S. Cl. 429/12; 502/215; 502/244; 502/344; 502/353

(57) ABSTRACT

A carbon monoxide oxidizing catalyst for a reformer of a fuel cell system comprises: a compound including selenium oxide, tellurium oxide, bismuth oxide, or a combination thereof; copper oxide; and cesium oxide.

### CROSS-REFERENCE TO RELATED APPLICATIONS

This application claims the benefit of Korean Application No. 2006-79975, filed Aug. 23, 2006, in the Korean Intellectual Property Office, the disclosure of which is incorporated herein by reference.

### BACKGROUND OF THE INVENTION

1. Field of the Invention

Aspects of the present invention relate to a carbon monoxide oxidizing catalyst for a reformer of a fuel cell system, a method of preparing the same, and a fuel cell system comprising the same. More particularly, aspects of the present invention relate to a carbon monoxide oxidizing catalyst having improved carbon monoxide oxidation activity and selectivity, and high efficiency at low temperatures.

2. Description of the Related Art

A fuel cell is a power generation device for producing electrical energy through an electrochemical redox reaction of an oxidant and a fuel. A suitable fuel can be hydrogen, or a hydrocarbon-based material, such as methanol, ethanol, natural gas, and the like. Such a fuel cell is a clean energy source that can reduce the need for fossil fuels. It comprises a stack composed of unit cells, and produces various ranges of power output. Since it has a four to ten times higher energy density than a small lithium battery, it has been highlighted as a small portable power source.

Representative exemplary fuel cells comprise a polymer electrolyte membrane fuel cell (PEMFC) and a direct oxidation fuel cell (DOFC). Direct oxidation fuel cell comprises direct methanol fuel cells that use methanol as a fuel.

A fuel cell system can comprise a stack that generates electricity. A stack can comprise several to scores of unit cells stacked adjacent to one another, with each unit cell formed of a membrane-electrode assembly (MEA) and a separator (also referred to as a bipolar plate). The membrane-electrode assembly is composed of an anode and a cathode that are separated by a polymer electrolyte membrane.

A fuel is supplied to the anode and adsorbed on catalysts of the anode, and oxidized to produce protons and electrons. The electrons are transferred into the cathode via an external circuit, and the protons are transferred to the cathode through the polymer electrolyte membrane. In addition, an oxidant is supplied to the cathode, and then the oxidant, protons, and electrons are reacted on the catalysts of the cathode to produce electricity along with water.

A fuel cell system is composed of a stack, a reformer, a fuel tank, and a fuel pump. The stack forms a body of the fuel cell system, and the fuel pump provides the fuel stored in the fuel tank to the reformer. The reformer reforms the fuel to generate the hydrogen gas and supplies the hydrogen gas to the stack.

A reformer of a general fuel cell system comprises a reforming reaction part that generates hydrogen gas from a fuel through a catalyst reforming reaction using heat energy, and a carbon monoxide reducing part that reduces a carbon monoxide concentration in the hydrogen gas through an oxidizing reaction of the hydrogen gas with oxygen. Such a reforming reaction is performed by a carbon monoxide oxidizing catalyst and therefore there is much research into a carbon monoxide oxidizing catalyst.

### SUMMARY OF THE INVENTION

Various aspects of the present invention provide a carbon monoxide oxidizing catalyst for a reformer of a fuel cell system having excellent carbon monoxide oxidation activity.

Other aspects of the present invention provide a method of preparing the carbon monoxide oxidizing catalyst.

Various embodiments of the present invention provide a fuel cell system comprising the carbon monoxide oxidizing catalyst.

According to various embodiments of the present invention, a carbon monoxide oxidizing catalyst for a reformer of a fuel cell system is provided, which comprise selenium oxide, tellurium oxide, bismuth oxide, copper oxide cesium oxide, or combinations thereof.

The carbon monoxide oxidizing catalyst can comprise a solid solution compound, comprising selenium oxide, tellurium oxide, bismuth oxide, or combinations thereof; copper oxide; and cesium oxide.

The carbon monoxide oxidizing catalyst can comprise an atom selected from the group consisting of selenium, tellurium, bismuth, or combinations thereof, and cesium in an atomic ratio of 0.01-0.5:1.

The carbon monoxide oxidizing catalyst may be supported on a carrier selected from the group consisting of Al₂O₃, TiO₂, SiO₂, and combinations thereof.

The carbon monoxide ocidizing catalyst my comprise selenium oxide, tellurium oxide, bismuth oxide, and combinations thereof; copper oxide; and cesium oxide, in a weight ratio of 0.1 to 1:4-5:15-45. According to various embodiments, the carbon monoxide oxidizing catalyst may comprise selenium oxide, tellurium oxide, bismuth oxide, or combinations thereof; copper oxide; and cesium oxide, in a weight ratio of 0.1-1:4-5:20-22.

According to various embodiments of the present invention, a method of preparing a carbon monoxide oxidizing catalyst for a reformer of a fuel cell system is provided, which comprises preparing a solution by mixing at least one precursor comprising a Se precursor, a Te precursor, a Bi precursor, or a combinations thereof, a Ce precursor, and an aqueous solution comprising copper; heating the solution while varying the temperature; and calcinating the heated solution.

According some embodiments of the present invention, a fuel cell system is provided, which comprises: a reformer comprising a reforming reaction part that generates hydrogen gas from a fuel through a catalyst reforming reaction using heat energy; a carbon monoxide reducing part that reduces a carbon monoxide concentration in the hydrogen gas through an oxidizing reaction of hydrogen gas with the oxidant; at least one electricity generating element for generating electrical energy by electrochemical reactions of the hydrogen gas and oxidant; a fuel supplier for supplying the fuel to the reforming reaction part; and an oxidant supplier for supplying the oxidant to the carbon monoxide reducing part and electricity generating element, respectively. The carbon monoxide reducing part comprises the carbon monoxide oxidizing catalyst.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram showing the structure of a fuel cell system according to various aspects of an embodiment of the present invention.

FIG. 2 shows temperature variation during a heating process.

FIG. 3 shows a concentration change of hydrogen gas and carbon monoxide depending on temperature at an outlet of the reformer comprising the carbon monoxide oxidizing catalyst according to Comparative Example 1.

FIG. 4 shows concentrations of carbon monoxide at an outlet of the reformer, comprising the carbon monoxide oxidizing catalysts according to Examples 1 to 4, and Comparative Example 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of various embodiments of the present invention will hereinafter be described in detail with reference to the accompanying drawings.

According to various embodiments of the present invention, a carbon monoxide oxidizing catalyst for a reformer of a fuel cell system is provided.

In general, a fuel cell system comprises an electricity generating element and a fuel supplier. A polymer electrolyte fuel cell system comprises a reformer adopted to reform a fuel to hydrogen gas.

The reformer according to various aspects of one embodiment comprises a reforming reaction part that generates hydrogen gas from a fuel through a catalyst reforming reaction using heat energy, and a carbon monoxide reducing part that reduces a carbon monoxide concentration in the hydrogen gas through an oxidizing reaction of hydrogen gas with the oxidant.

In the carbon monoxide reducing part, the preferential oxidation (PROX) of carbon monoxide occurs. Through the preferential oxidation, the carbon monoxide content, included with the hydrogen gas as an impurity, is reduced to a ppm level. It is beneficial to reduce the carbon monoxide content since it poisons fuel cell catalysts, thereby deteriorating electrode performance.

Platinum-grouped metals such as Pt, Rh, Ru, and so on are used for a conventional preferential oxidation process. However, these metals are costly and have a low selectivity. Recently, transition element catalysts have been researched. For example, a combinational transition element catalyst such as a Cu—CeO₂ catalyst has been suggested to have improved CO oxidation reaction activity relative to a Cu only catalyst.

However, there are still needs for a catalyst having more improved CO oxidation reaction activity.

The carbon monoxide oxidizing catalyst for a reformer of a fuel cell system according to aspects of one embodiment of the present invention comprise a compound selected from the group consisting of selenium oxide, tellurium oxide, bismuth oxide, and combinations thereof; copper oxide; and cesium oxide.

The carbon monoxide oxidizing catalyst comprising selenium, tellurium, or bismuth, has a larger oxygen storage capability than a conventional carbon monoxide oxidizing catalyst. When the concentration of the oxidant increases in the carbon monoxide oxidizing catalyst, the carbon monoxide oxidizing activity of the catalyst is improved and the selectivity of the catalyst is improved even at lower temperatures. Thus, it is possible to acquire a high carbon monoxide conversion rate at a lower temperature.

The carbon monoxide oxidizing catalyst can comprise a solid solution comprising: a compound selected from the group consisting of selenium oxide, tellurium oxide, bismuth oxide, and combinations thereof; copper oxide; and cesium oxide. Such a compound may improve the activity of the carbon monoxide oxidizing catalyst.

The carbon monoxide oxidizing catalyst can comprise an atom selected from the group consisting of selenium, tellurium, bismuth, and combinations thereof, and cesium in an atomic ratio of 0.01-0.5:1.

When the atomic ratio of selenium, tellurium, or bismuth to cesium is less than 0.01, the addition of the selenium, tellurium, or bismuth to the carbon monoxide oxidizing catalyst can have little effect on increasing the activity of the catalyst. When the atomic ratio of selenium, tellurium, or bismuth to cesium exceeds 0.5, the selenium, tellurium, or bismuth can form a large oxide, and thereby decrease the desired characteristics of the carbon monoxide oxidizing catalyst.

The carbon monoxide oxidizing catalyst may be supported by a carrier selected from the group consisting of Al₂O₃, TiO₂, SiO₂, and combinations thereof. For example the carbon monoxide oxidizing catalyst may be supported by Al₂O₃.

The carbon monoxide oxidizing catalyst may comprise a compound selected from the group consisting of selenium oxide, tellurium oxide, bismuth oxide, and combinations thereof; copper oxide; and cesium oxide, in a weight ratio of 0.1-1:4-5:15-45, respectively. According to aspects of another embodiment, the carbon monoxide oxidizing catalyst may comprise a compound selected from the group consisting of selenium oxide, tellurium oxide, bismuth oxide, or combinations thereof; copper oxide; and cesium oxide, in a weight ratio of 0.1-1:4-5:20-22, respectively.

When the weight ratio of the compound selected from the group consisting of selenium oxide, tellurium oxide, bismuth oxide, or combinations thereof is less than 0.1, there is little increase in the catalytic activity for the carbon monoxide oxidation-reaction. When the weight ratio exceeds 1, the catalytic activity for the carbon monoxide oxidation reaction can decrease, which is undesirable.

When the weight ratio of copper oxide is less than 4, there is little increase in the catalytic activity for the carbon monoxide oxidation reaction. When the weight ratio exceeds 5, the catalytic effect for the carbon monoxide oxidation reaction can decrease, which is undesirable.

When the weight ratio of cesium oxide is less than 15, there is little increase in the oxidant storage capacity of the carbon monoxide oxidizing catalyst. When the weight ratio exceeds 45, a stable solid solution can be difficult to form, which can be undesirable.

The carbon monoxide oxidizing catalyst can be prepared as follows.

At least one precursor selected from the group consisting of a Se precursor, a Te precursor, a Bi precursor, and combinations thereof; a Ce precursor; and an aqueous solution comprising copper; were mixed to prepare a mixed solution.

The concentration of the aqueous solution comprising copper may be controlled before mixing.

When the carbon monoxide oxidizing catalyst is to be supported by a carrier, the carrier can be added to the mixed solution.

The mixed solution is heated at a varying temperature between about 200° C. and about 500° C., while being stirred, and it is evaporated to thereby produce a solid. The solid is calcinated, to prepare the carbon monoxide oxidizing catalyst according to various embodiments.

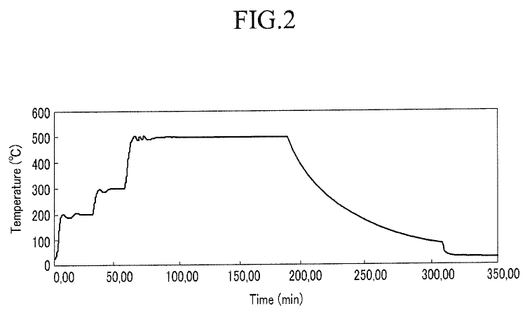

An example of a temperature variance when heating is illustrated in FIG. 2. Referring to FIG. 2, the heating is shown to be performed in three steps. The first step is performed at 200° C., the second step is performed at 300° C., and the third step is performed at 550° C. for two hours.

The Ce precursor can comprise, for example, Ce(NO₃)₂.6H₂O, (NH₄)₂Ce(NO₃)₆, or combinations thereof.

The Se precursor can comprise, for example, H₂SeO₃, and the Te precursor can comprise H₂TeO₃, and the Bi precursor can comprise Bi₂O₃.

The Cu-containing aqueous solution may be prepared by mixing a Cu precursor and water at a ratio of 1.2-1.9 g:4.5-5.0 ml. Examples of the Cu precursor comprise Cu(NO₃)₂.3H₂O, Cu(NO₃)₂.2.5H₂O, and the like.

According to various embodiments, the calcination is carried out at a temperature ranging from about 450° C. to about 550° C., for between about 2 to about 6 hours. When the temperature is lower than 450° C., the calcination can be incomplete. When the temperature exceeds 550° C., the porous structure of the first carbon monoxide oxidizing catalyst may be damaged. Also, when the calcination is performed for less than 2 hours, the calcination can be incomplete. When it is performed for more than six hours, the benefits can be limited.

A fuel cell system according to various embodiments of the present invention comprises: a reformer comprising a reforming reaction part to generate hydrogen gas from a fuel through a catalyst reforming reaction using heat energy: a carbon monoxide reducing part to reduce a carbon monoxide concentration in the hydrogen gas through an oxidizing reaction of hydrogen gas with the oxidant; at least one electricity generating element to generate electrical energy by electrochemical reactions of the hydrogen gas and the oxidant; a fuel supplier to supply the fuel to the reforming reaction part; and an oxidant supplier to supply the oxidant to the carbon monoxide reducing part and electricity generating element, respectively. The carbon monoxide reducing part comprises the carbon monoxide oxidizing catalyst.

The fuel cell system may further comprise a cooler to reduce the heat generated in the carbon monoxide reducing part by circulating the fuel supplied to the reforming reaction part through the carbon monoxide reducing part.

Hereinafter, aspects of the embodiments of the present invention will be described in detail such that they can be easily implemented by those skilled in the art of the present invention. However, aspects of the present invention may be realized in different forms and are not limited to the embodiments described herein.

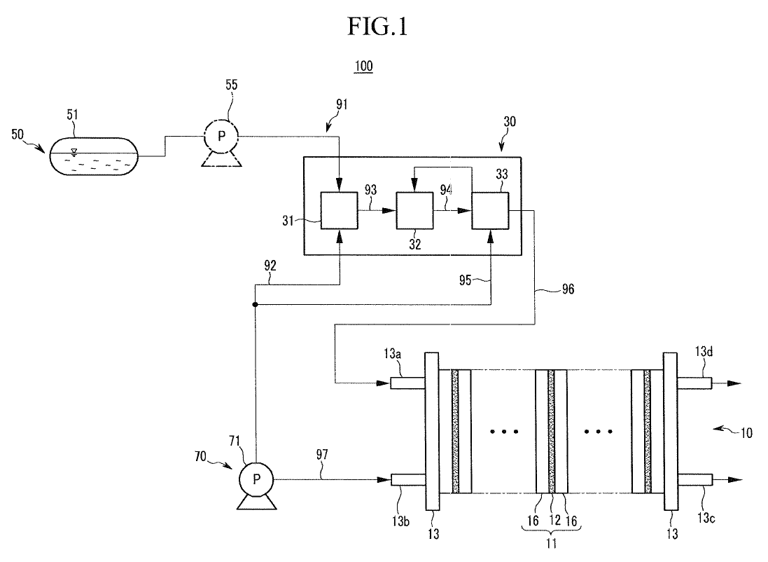

Hereinafter, a fuel cell system will be described referring to FIG. 1, a schematic diagram showing the structure of a fuel cell system.

As shown in FIG. 1, the fuel cell system 100 comprises: a stack 10 comprising an electricity generating element 11 to generate electrical energy through electrochemical reactions; a reformer 30 to generates hydrogen gas from a liquid fuel and supplies the hydrogen gas; a fuel supplier 50 to supply a fuel to the reformer 30; and an oxidant supplier 70 to supply an oxidant to the reformer 30, and the electricity generating element 11, respectively.

The electricity generating element 11 is formed as a minimum unit for generating electricity by disposing a membrane-electrode assembly (MEA) 12 between two separators 16, and then the stack 10 is formed with a stacked structure by arranging a plurality of minimum units. The membrane-electrode assembly 12 comprises an anode and a cathode, and performs hydrogen gas oxidation and oxidant reduction reactions. The separators 16 supply hydrogen gas and an oxidant through gas passage paths formed at both sides of the membrane-electrode assembly 12, and also function as conductors connecting the anode and the cathode in series.

The stack 10 can additionally comprise pressing plates 13, to position a plurality of the electricity generating elements 11 closely adjacent to each other, at the outermost ends of the stack 10. However, the stack 10 of a fuel cell according to aspects of the present embodiment can be formed by positioning separators 16 at the outermost ends of the electricity generating elements 11, to press the electricity generating elements 11, instead of using the separate pressing plates 13. On the contrary, the pressing plates 13 can be formed to intrinsically function as the separators 16, in addition to closely arranging the plurality of electricity generating elements 11.

The pressing plates 13 comprise a first inlet 13a to supply hydrogen gas to the electricity generating elements 11, a second inlet 13b to supply oxidant to the electricity generating elements 11 from the oxidant supplier 40, a first outlet 13c to release hydrogen gas remaining after a reaction at the anodes of the membrane-electrode assemblies 12, and a second outlet 13d to release non-reacted air comprising moisture generated through a reduction reaction of the oxidant at the cathodes of the membrane-electrode assemblies 12. The oxidant may be air. When the oxidant is air, the air may be supplied through the oxidant supplier 70.

The reformer 30 has a structure to generate hydrogen gas from a fuel by chemical catalytic reactions using heat energy, and to reduce the carbon monoxide concentration in the hydrogen gas.

The reformer 30 comprises: a heating source 31 to generate heat energy through a catalytic oxidizing reaction of the fuel and the oxidant; a reforming reaction part 32 to generate hydrogen gas from the fuel through a steam reforming (SR) catalyst reaction by the heat energy; and a carbon monoxide reducing part 33 to reduce the concentration of the carbon monoxide included in the hydrogen gas.

In aspects of the present invention, the reaction of the reformer 30 is not limited to the steam reforming catalyst reaction, and may comprise an auto-thermal reforming (ATR) reaction or a partial oxidation reaction (POX) performed without the use of the heating source 31.

The heating source 31 is connected to a fuel pump 55, through a first supply line 91, and is connected to an oxidant pump 71, through a second supply line 92. Supply lines as described herein, can be conduits having structures suitable for directing fluids, for example, a channel, a pipe, or a tube structure. The liquid fuel and oxidant pass through the heating source 31. The heating source 31 comprises a catalyst layer (not shown) to accelerate the oxidizing reaction of the fuel with the oxidant, to generate the heat energy. Herein, the heating source 31 is formed as a plate that provides a channel (not shown), capable of channeling the liquid fuel and the oxidant. The surface of the channel is coated with the catalyst layer. The heating source 31 is shaped as a cylinder that has a defined internal space. The internal space may be filled with a catalyst layer such as a pellet-type catalyst module, or a honeycomb-type catalyst module.

The reforming reaction part 32 absorbs the heat energy generated from the heating source 31, to generate the hydrogen gas, through the steam-reforming catalyst reforming reaction of the fuel supplied from the fuel tank 51. The reforming reaction part 32 is directly connected to the heating source 31, via a third supply line 93. In addition, the reforming reaction part 32 comprises a catalyst layer (not shown) to accelerate the steam reforming reaction of the fuel into hydrogen.

The carbon monoxide reducing part 33 reduces the carbon monoxide concentration in the hydrogen gas through a preferential CO oxidation catalyzed reaction of the CO with air. The hydrogen gas is generated from the reformer reaction part 32 and the air is supplied from the oxidant pump 71. The carbon monoxide reducing part 33 is connected to the reformer reaction part 32 via a fourth supply line 94, and to the oxidant pump 71 via a fifth supply line 95. Thus, the hydrogen gas and the oxidant pass through the carbon monoxide reducing part 33.

The carbon monoxide reducing part 33 is coated with a catalyst layer (not shown) comprising the carbon monoxide oxidizing catalyst that promotes a preferential oxidation reaction between the CO and an oxidant, and thereby reduces carbon monoxide concentration in the hydrogen gas. Herein, the carbon monoxide reducing part 33 comprises a plate-shaped channel (not shown) capable of channeling the hydrogen gas and oxidant. The surface of the channel is coated with the catalyst layer. The carbon monoxide reducing part 33 is shaped as a cylinder that has a defined internal space. The internal space may be filled with a catalyst layer such as a pellet-type catalyst module or a honeycomb-type catalyst module.

Herein, the carbon monoxide reduction part 33 is connected to the first inlet 13a of the stack 10, via a sixth supply line 96. The carbon monoxide reduction part 33 provides the electricity generating elements 11, of the stack 10, with the hydrogen gas having a reduced carbon monoxide concentration . In addition, the carbon monoxide reduction part 33 may comprise thermally conductive stainless steel, aluminum, copper, iron, and on the like.

The following examples illustrate aspects of the present invention in more detail. However, it is understood that the present invention is not limited by these examples. In some instances, the following description describes a solid solution. A solid solution is generally a mixture of a solvent and solute where the crystal structure of the solvent remains unchanged by addition of the solutes, and when the mixture remains in a single homogeneous phase. The solute may incorporate into the solvent crystal lattice substitutionally, by replacing a solvent particle in the lattice, or interstitially, by fitting into the space between solvent particles. Both of these types of solid solution affect the properties of the material by distorting the crystal lattice and disrupting the physical and electrical homogeneity of the solvent material.

### EXAMPLE 1

10.596 g of Ce(NO₃)₂.6H₂O and 0.035 g of H₂SeO₃ were dissolved in 10 ml of a Cu(NO₃)₂.3H₂O aqueous solution that was prepared by dissolving 2.599 g of Cu(NO₃)₂.3H₂O in 10 ml of water to prepare a concentrated solution. 20 ml of Al₂O₃ (14.8 g) was added to the solution. While stirring, the solution was variably heated to the temperatures as shown in FIG. 2, and the solution was thereby evaporated to obtain a compound (solid). The compound was calcinated at 500° C. for 5 hours to obtain a solid solution carbon monoxide oxidizing catalyst comprising 4.30 wt % of CuO, 21.12 wt % of CeO₂, and 0.15 wt % of SeO₂ supported on Al₂O₃.

### EXAMPLE 2

A solid solution carbon monoxide ocidizing catalyst comprising 4.30 wt % of CuO, 21.09 wt % of CeO₂, and 0.3 wt % of SeO₂ supported on Al₂O₃ was prepared according to the same method as in Example 1, except that 10.596 g of Ce(NO₃)₂.6H₂O and 0.069 g of H₂SeO₃ were dissolved in 10 ml of a Cu(NO₃)₂.3H₂O aqueous solution that was prepared by dissolving 2.599 g of Cu(NO₃)₂.3H₂O in 10 ml of water.

### EXAMPLE 3

A solid solution carbon monoxide oxidizing catalyst comprising 4.29 wt % of CuO, 21.07 wt % of CeO₂, and 0.4 wt % of SeO₂, supported on Al₂O₃,was prepared according to the same method as in Example 1, except that 10.596 g of Ce(NO₃)₂0.6H₂O and 0.092 g of H₂SeO₃were dissolved in 10 ml of a Cu(NO₃)₂.3H₂O aqueous solution that was prepared by dissolving 2.599 g of Cu(NO₃)₂.3H₂O in 10 ml of water.

### EXAMPLE 4

A solid solution carbon monoxide oxidizing catalyst comprising 4.28 wt % of CuO, 21.03 wt % of CeO₂, and 0.6 wt % of SeO₂ supported on Al₂O₃, was prepared according to the same method as in Example 1, except that 10.596 g of Ce(NO₃)₂.6H₂O and 0.138 g of H₂SeO₃ were dissolved in 10 ml of a Cu(NO₃)₂.3H₂O aqueous solution that was prepared by dissolving 2.599 g of Cu(NO₃)₂.3H₂O in 10 ml of water.

### COMPARATIVE EXAMPLE 1

0.011536 mol (5.01 g) of Ce(NO₃)₂.6H₂O was dissolved in 8.00 ml of a Cu(NO₃)₂.3H₂O aqueous solution that was prepared by dissolving 162.34 g of Cu(NO₃)₂.3H₂O in 3.8 ml of water to obtain a solution. A small amount of water was added to the solution to prepare a concentrated solution. 10 ml of Al₂O₃ (7.4 g) was added to the solution. While stirring the solution, the solution was heated and evaporated to obtain a compound. The compound was calcinated at 500° C. to obtain a solid solution carbon monoxide oxidizing catalyst comprising 4 wt % of CuO and 76 wt % of CeO₂ 76 wt % supported on Al₂O₃.

A gas comprising CO₂ at 14.38%, H₂ at 39.23%, N₂ at 12.29%, CH₄ at 0.33%, CO at 0.31%, O₂ at 0.30%, and H₂O at 33.16% was flowed to reformers loaded with the carbon monoxide oxidizing catalyst prepared according to Examples 1 to 4 and Comparative Example 1, in an amount of 10 ml, respectively, at a flux of 1203 ml/min, and a space velocity of 7222 h⁻¹.

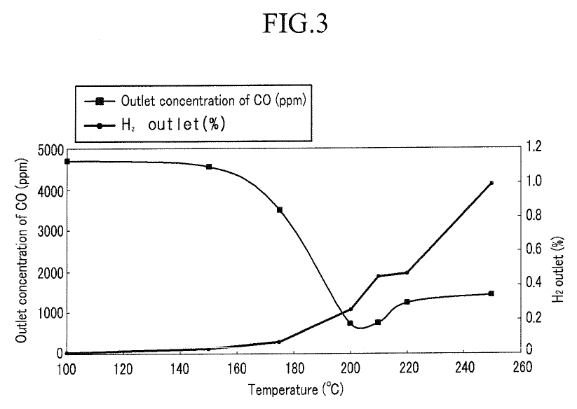

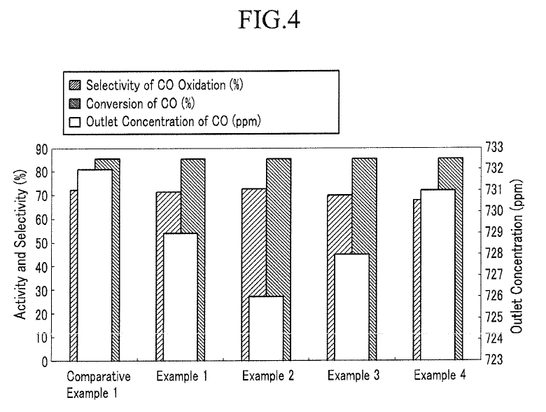

The composition of hydrogen gas and carbon monoxide at the outlet of the reformer using the carbon monoxide oxidizing catalyst of Comparative Example 1 according to the temperature variance is shown in FIG. 3, was measured. It can be seen from FIG. 3 that when the temperature at the outlet of the reformer was 200° C., the concentration of exhausted carbon monoxide was the least. The loss of H₂, the selectivity of CO oxidation, the CO conversion rate, the concentration of exhausted CO, and the exhausted quantity of H₂ at the outlet of the reformers using the carbon monoxide oxidizing catalysts of Examples 1 to 4 according to a temperature variance, are presented in Tables 1 to 4, respectively. The concentration of carbon monoxide at 200° C. is shown in FIG. 4.

Also, the atomic ratios of selenium to cesium in the carbon monoxide oxidizing catalysts prepared according to Examples 1 to 4 are shown in Table 5.

TABLE 1
Carbon monoxide oxidizing catalyst of Example 1

| | Temperature (° C.) | | | | | | |
|---|---|---|---|---|---|---|---|
| | 100 | 150 | 175 | 200 | 210 | 220 | 250 |
| H₂ loss (%) | 0.01 | 0.02 | 0.06 | 0.27 | 0.31 | 0.45 | 1.02 |
| CO oxidation | 83.56 | 79.41 | 79.78 | 71.49 | 68.16 | 56.73 | 33.87 |
| selectivity (%) | | | | | | | |
| CO conversion rate | 7.36 | 8.32 | 27.65 | 85.23 | 84.43 | 75.82 | 66.59 |
| (%) | | | | | | | |
| Released CO | 4560 | 4514 | 3563 | 729 | 761 | 1196 | 1661 |
| concentration (ppm) | | | | | | | |
| Released H₂ amount | 480 | 480 | 480 | 479 | 479 | 478 | 475 |
| (ml/min) | | | | | | | |

TABLE 2
Carbon monoxide oxidizing catalyst of Example 2

| | Temperature (° C.) | | | | | | |
|---|---|---|---|---|---|---|---|
| | 100 | 150 | 175 | 200 | 210 | 220 | 250 |
| H₂ loss (%) | 0.01 | 0.02 | 0.06 | 0.26 | 0.31 | 0.45 | 1.06 |
| CO oxidation | 87.25 | 84.91 | 80.23 | 72.67 | 68.4 | 57 | 32.99 |
| selectivity (%) | | | | | | | |
| CO conversion rate | 8.15 | 9.43 | 29.77 | 85.29 | 84.65 | 76.41 | 66.17 |
| (%) | | | | | | | |
| Released CO | 4521 | 4459 | 3459 | 726 | 753 | 1166 | 1683 |
| concentration (ppm) | | | | | | | |
| Released H₂ amount | 480 | 480 | 480 | 479 | 479 | 478 | 475 |
| (ml/min) | | | | | | | |

TABLE 3
Carbon monoxide oxidizing catalyst of Example 3

| | Temperature (° C.) | | | | | | |
|---|---|---|---|---|---|---|---|
| | 100 | 150 | 175 | 200 | 210 | 220 | 250 |
| H₂ loss (%) | 0.01 | 0.02 | 0.07 | 0.29 | 0.33 | 0.51 | 1.07 |
| CO oxidation | 91.44 | 79.06 | 78.12 | 69.98 | 66.94 | 53.67 | 31.81 |
| selectivity (%) | | | | | | | |
| CO conversion rate | 7.96 | 8.97 | 29.62 | 85.26 | 84.85 | 75.99 | 63.8 |
| (%) | | | | | | | |
| Released CO | 4531 | 4481 | 3466 | 728 | 748 | 1188 | 1801 |
| concentration (ppm) | | | | | | | |
| Released H₂ amount | 480 | 480 | 480 | 479 | 478 | 478 | 475 |
| (ml/min) | | | | | | | |

TABLE 4
Carbon monoxide oxidizing catalyst of Example 4

| | Temperature (° C.) | | | | | | |
|---|---|---|---|---|---|---|---|
| | 100 | 150 | 175 | 200 | 210 | 220 | 250 |
| H₂ loss (%) | 0.01 | 0.03 | 0.1 | 0.32 | 0.34 | 0.53 | 1.11 |
| CO oxidation | 88.59 | 70.31 | 69.15 | 67.84 | 65.99 | 51.9 | 29.79 |
| selectivity (%) | | | | | | | |
| CO conversion rate | 5.46 | 8.74 | 28.23 | 85.2 | 84.71 | 73.51 | 59.75 |
| (%) | | | | | | | |
| Released CO | 4653 | 4493 | 3536 | 731 | 755 | 1311 | 2003 |
| concentration (ppm) | | | | | | | |
| Released H₂ amount | 480 | 480 | 480 | 478 | 478 | 477 | 475 |
| (ml/min) | | | | | | | |

TABLE 5

| | Atomic ratio | | |
|---|---|---|---|
| | Cu/Ce | Se/Ce | Al/Ce |
| Example 1 | 0.440975 | 0.010999 | 11.8965 |
| Example 2 | 0.440975 | 0.021997 | 11.8965 |
| Example 3 | 0.440975 | 0.02933 | 11.8965 |
| Example 4 | 0.440975 | 0.043995 | 11.8965 |

Referring to Tables 1 to 4 and FIG. 4, Examples 1 to 4, using a carbon monoxide oxidizing catalyst comprising selenium oxide added thereto, showed a decreased concentration of exhausted carbon monoxide at the outlet of the reformer, as compared to Comparative Example 1. Also, referring to Table 5 and FIG. 4, when the carbon monoxide oxidizing catalyst comprised selenium and cesium, at an atomic ratio of 0.01:1 to 0.5:1, the exhausted quantity of carbon monoxide decreased more. When it comprised selenium and cesium, in an atomic ratio of about 0.02:1, as in Example 2, the exhausted quantity of carbon monoxide was decreased remarkably.

Since the carbon monoxide oxidizing catalyst comprises at least one selected from the group consisting of selenium, tellurium, bismuth, or combinations thereof, it is possible to improve the catalyst activity for oxidizing carbon monoxide, improve the selectivity of the catalyst at a low temperature, and acquire a high carbon monoxide conversion rate at a low temperature.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A carbon monoxide oxidizing catalyst, comprising:
a compound selected from the group consisting of selenium oxide, tellurium oxide, bismuth oxide, and combinations thereof;
copper oxide; and
cesium oxide.

2. The carbon monoxide oxidizing catalyst of claim 1, wherein the carbon monoxide oxidizing catalyst comprises a solid solution.

3. The carbon monoxide oxidizing catalyst of claim 1, wherein the compound and cesium respectively comprise an atomic ratio of 0.01-0.5:1.

4. The carbon monoxide oxidizing catalyst of claim 1, further comprising a carrier selected from the group consisting of Al₂O₃, TiO₂, SiO₂, and combinations thereof.

5. The carbon monoxide oxidizing catalyst of claim 1, wherein the compound, the copper oxide, and the cesium oxide, respectively comprise a weight ratio of 0.1-1:4-5:15-45.

6. The carbon monoxide oxidizing catalyst of claim 5, wherein the compound, the copper oxide, and the cesium oxide, respectively comprise a weight ratio of 0.1-1:4-5:20-22.

7. A method of preparing a carbon monoxide oxidizing, comprising:
preparing a solution by mixing at least one precursor selected from the group consisting of a Se precursor, a Te precursor, a Bi precursor, and combinations thereof, a Ce precursor, and an aqueous solution comprising copper;
heating the solution while varying the temperature to produce a solid; and
calcinating the solid.

8. The method of claim 7, wherein the Ce precursor is at least one selected from the group consisting of Ce(NO₃)₂.6H₂O, (NH₄)₂Ce(NO₃)₆, and combinations thereof.

9. The method of claim 7, wherein the Se precursor comprises H₂SeO₃, the Te precursor comprises H₂TeO₃, and the Bi precursor comprises Bi₂O₃.

10. The method of claim 7, wherein the aqueous solution comprising copper is prepared by dissolving 120 g to 190 g of a copper precursor in 450 ml to 500 ml of water.

11. The method of claim 10, wherein the copper precursor is at least one selected from the group consisting of Cu(NO₃)₂.3H₂O, Cu(NO₃)₂.2.5H₂O, and combinations thereof.

12. The method of claim 7, wherein the heating of the solution comprises heating the solution to a temperature of from 200° C. to 500° C.

13. The method of claim 12, wherein the heating of the solution comprises by a first heat-treatment at 200° C., a second heat-treatment at 300° C., and a third heat-treatment at 550° C.

14. The method of claim 7, wherein the calcinating of the solid comprises heating the solid to a temperature of from 450° C. to 550° C.

15. The method of claim 7, wherein the calcinating of the solid comprises heating the solid for from 2 hours to 6 hours.

16. A fuel cell system comprising:
a reformer comprising a reforming reaction part that generates hydrogen gas from a fuel through a catalyst reforming reaction using heat energy, and a carbon monoxide reducing part that reduce a carbon monoxide concentration in the hydrogen gas through an oxidizing reaction of hydrogen gas with the oxidant;
at least one electricity generating element to generate electrical energy by electrochemical reactions of the hydrogen gas and the oxidant;
a fuel supplier for supplying the fuel to the reforming reaction part; and
an oxidant supplier to supply the oxidant to the carbon monoxide reducing part and electricity generating element, respectively,
wherein the carbon monoxide reducing part comprises a carbon monoxide oxidizing catalyst, comprising:
a compound selected from the group consisting of selenium oxide, tellurium oxide, bismuth oxide, and combination, thereof;
copper oxide; and
cesium oxide.

17. The fuel cell system of claim 16, wherein the carbon monoxide oxidizing catalyst comprises a solid solution.

18. The fuel cell system of claim 16, wherein the carbon monoxide oxidizing catalyst comprises the compound and cesium, in an atomic ratio of from 0.01-0.5:1, respectively.

19. The fuel cell system of claim 16, wherein the carbon monoxide oxidizing catalyst is supported on a carrier selected from the group consisting of Al₂O₃, TiO₂, SiO₂, and combinations thereof.

20. The fuel cell system of claim 16, wherein the carbon monoxide oxidizing catalyst comprises the compound, the copper oxide; and the cesium oxide, in a weight ratio of 0.1-1:4-5:15-45, respectively.

21. The fuel cell system of claim 20, wherein the carbon monoxide oxidizing catalyst comprises a compound selected from the group consisting of selenium oxide, tellurium oxide, bismuth oxide, and combinations thereof; copper oxide; and cesium oxide, in a weight ratio of 0.1-1:4-5:20-22, respectively.

22. The carbon monoxide oxidizing catalyst of claim 1, wherein the compound consists of selenium oxide.

23. The carbon monoxide oxidizing catalyst of claim 22, further comprising an Al₂O₃ carrier.

24. The carbon monoxide oxidizing catalyst of claim 22, wherein the selenium oxide and the cesium oxide are in an atomic ratio of about 0.02:1.

25. The method of claim 7, wherein the calcinating of the solid comprises converting the solid to a solid mixture.

26. The method of claim 7, further comprising adding a carrier to the solution.

27. The method of claim 26, wherein the carrier comprises one of Al₂O₃, TiO₂, SiO₂, and a combination thereof.
